(19) United States
(12) Patent Application Publication
(10) Pub. No.: US 2002/0046112 A1
(43) Pub. Date: Apr. 18, 2002

(54) Employee information communication apparatus and method

(75) Inventors: Hiroshi Nitta, Hiroshima (JP); Mayumi Nagatani, Hiroshima (JP); Fumie Oka, Hiroshima (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/919,844

(22) Filed: Aug. 2, 2001

(30) Foreign Application Priority Data
Aug. 3, 2000 (JP) 2000-236011

(51) Int. Cl. G06F 17/60; G06F 7/00; G06F 17/30

(52) U.S. Cl. 705/14; 707/3

(57) ABSTRACT

An employee information apparatus, including a first electronic data structure that stores employee information including at least one of employee name, employee company, employee number and employee password, a second electronic data structure that stores advertising information from a first source, a third electronic data structure that stores employee detailed wage information including at least one of employee number, employee company, employee name, payment amounts, deduction amounts and date of payment from a second source and an image generator that receives an inquiry from an employee and generates a detailed wage image that includes advertising information, employee information and employee detailed wage information.

### CROSS REFERENCE TO RELATED APPLICATIONS

This application is based upon and claims the priority of Japanese Patent Application No. 2000-270728 filed Sep. 6, 2000, the contents being incorporated herein by reference.

### BACKGROUND OF THE INVENTION

1. Field of the invention

The invention relates to a communications apparatus and method for handling multiple electronic formats to deliver employee information and sales information to relevant parties.

2. Description of the Related Art

Employees are normally provided information about their wages when they receive a check from their employer. This information can be detailed and is usually required by various tax collection agencies. Employers therefore normally provide this information as a printout with an employee's check or with the notification of payment.

As an improvement to printing the data presented to the employee, it is also known to use a web-based Intranet to provide the detailed wage information to employees. However, the creation and maintenance of an Intranet solely for the use of the company's employees consumes a great deal of time and effort. Because of the great time and effort involved in creating and maintaining these web-based Intranet systems and related databases, there are few features to the web-based Intranet systems and no provisions for an employee to engage in what-if scenarios.

Conversely, advertising is now being commonly used as a way to defray expenses of producing and maintaining various employee information apparatus and methods and related databases. However, the common use of advertising results in significant issues about privacy and access to sensitive information. Employees are concerned that sensitive information can be easily obtained and used in a manner that does not truly reflect their economic status. The economic status of employees can be combined into demographic information that is the basis of advertising campaigns. Employees can be concerned that demographic data can be misinterpreted in preparing advertising campaigns.

Advertisers wish to use demographic information about individuals when targeting their advertisement. The use of demographic profiling is well known and considered advantageous when pricing a specific advertisement. However, the use of demographic profiling increases concerns about privacy and access to sensitive data. At present, advertisers are restricted in their ability to use demographic data in presenting advertisements to employees. These restrictions reduce the amount advertisers are willing to spend.

### SUMMARY OF THE INVENTION

A first exemplary employee information apparatus and method, in accordance with the invention, allows for focused advertising using demographic data in a manner that protects the privacy of the employees and the company. The employees gain detailed wage data and are allowed to perform what-if analyses on their wage statements. The company is able to provide employees with superior service concerning information about the employee's wage statement, at a reduced cost because of the advertiser's input.

In accordance with the invention, the exemplary employee information apparatus and method can provide these noted advantages by presenting to the advertising companies a series of criteria to focus their advertisements. The advertising companies' advertisements can be then stored in an employee information apparatus or method that is controlled by the company and presented to employees that meet the subjected criteria. The employees receive ads that are more targeted and more likely to be useful. The advertising companies are better able to target their advertising to increase sales. The privacy and access to sensitive information issues are addressed, in this exemplary embodiment, by having the employee information apparatus controlled by someone other than the source company or the advertising company.

In accordance with another exemplary embodiment of the invention, there is provided a wage information apparatus that has a first electronic data structure that stores employee information including at least one of employee name, employee company, employee number and employee password; a second electronic data structure that stores advertising information from a first source; a third electronic data structure that stores employee detailed wage information including at least one of employee number, employee company, employee name, payment amounts, deduction amounts and date of payment from a second source; and an image generator that receives an inquiry from an employee and generates a detailed wage image that includes advertising information, employee information and employee detailed wage information.

In accordance with another exemplary embodiment of the invention, there is provided an employee information method that has the following actions, electronically storing employee information including at least one of employee name, employee company, employee number and employee password; electronically storing advertising information from a first source, electronically storing employee detailed wage information including at least one of employee number, employee company, employee name, payment amounts, deduction amounts and date of payment from a second source; receiving an inquiry from an employee; and generating a detailed wage image that includes advertising information, employee information and employee detailed wage information.

In accordance with another exemplary embodiment of the invention, there is provided a employee information apparatus that has a first electronic data storage device that stores employee information including at least one of employee name, employee company, employee number and employee password; a second electronic data storage device that stores advertising information from a first source; a third electronic data storage device that stores employee detailed wage information including at least one of employee number, employee company, employee name, payment amounts, deduction amounts and date of payment from a second source; and an image generator that receives an inquiry from an employee and generates a detailed wage image that includes advertising information, employee information and employee detailed wage information.

The various embodiments discussed above can additionally include a fourth electronic data structure that stores confirmation information when the employee submits the inquiry and receives the detailed wage image or that stores purchase information when an employee utilizes the advertising information. In addition the information can be forwarded to the company if the information is confirmation information or forwarded to the advertising company if the information is purchase information.

Another exemplary embodiment of the invention is a wage information management apparatus, with a detailed wage data structure that stores details of an employee's wage, a detailed wage inquiry authenticator that authenticates a wage inquiry based on an authentication code in the wage inquiry, a communicator that, when the detailed wage authenticator authenticates the wage inquiry, sends the detailed wage data to a source of the wage inquiry; a deduction information collector that accepts a deduction information from the source of the wage inquiry and a deduction information recorder that records the deduction information sent from the source of the wage inquiry.

Other exemplary embodiments of the wage information management apparatus can have a confirmation data structure that stores confirmation information when the source submits the wage inquiry and the communicator sends the detailed wage data. In addition, the wage information management apparatus can have the confirmation information sent to a second source.

The various embodiments discussed above can additionally include the case where the advertising information being generated includes information tailored to at least one of an employee income level, an employee organizational unit and an employee information input.

### BRIEF DESCRIPTION OF THE DRAWINGS

These and other objects and advantages of the present invention will become more apparent and more readily appreciated from the following description of the preferred exemplary embodiments, taken in conjunction with the accompanying drawings of which:

FIG. 1 is a block diagram of an exemplary embodiment of an employee information apparatus in accordance with the present invention;

FIG. 2 is a block diagram of another exemplary employee information apparatus:

FIG. 3 is an exemplary diagram of information flow of employee wage information in the employee information apparatus of FIG. 1;

FIG. 4 is an exemplary diagram of authentication of a wage inquiry for wage in the employee information apparatus of FIG. 1;

FIG. 5 is an explanatory diagram illustrating information flow for a what-if scenario as used by the wage information apparatus of FIG. 1;

FIG. 6 is an exemplary embodiment of a method of inserting an advertisement into the result of the what-if testing of the wage information apparatus of FIG. 1;

FIG. 7 is an exemplary embodiment of a method for determining advertisement results of the wage information apparatus of FIG. 1;

FIG. 8 is an exemplary embodiment of a screen shot of a what-if scenario that may be used by the wage information apparatus of FIG. 1;

FIGS. 9A and 9B are exemplary tables showing data structures that can be used in the employee information apparatus of FIG. 1;

FIGS. 10A and 10B are exemplary tables showing the data structure that can be used in the advertisement and simulation information within the employee information apparatus of FIG. 1;

FIG. 11 is an exemplary table showing a data structure of an information verification portion of an employee information apparatus and method in accordance with the embodiments of the present invention;

FIGS. 12A and 12B are exemplary tables showing a data structure allowing a employee to order a product advertised by the advertising company in accordance with the embodiments of the present invention; and

FIGS. 13A and 13B are exemplary tables showing a data structure for analyzing employee information in accordance with embodiments of the present invention.

### DETAILED DESCRIPTION OF PREFERRED EMBODIMENTS

Reference will now be made in detail to the preferred embodiments of the present invention, examples of which are illustrated in the accompanying drawings, wherein like reference numerals refer to like elements throughout.

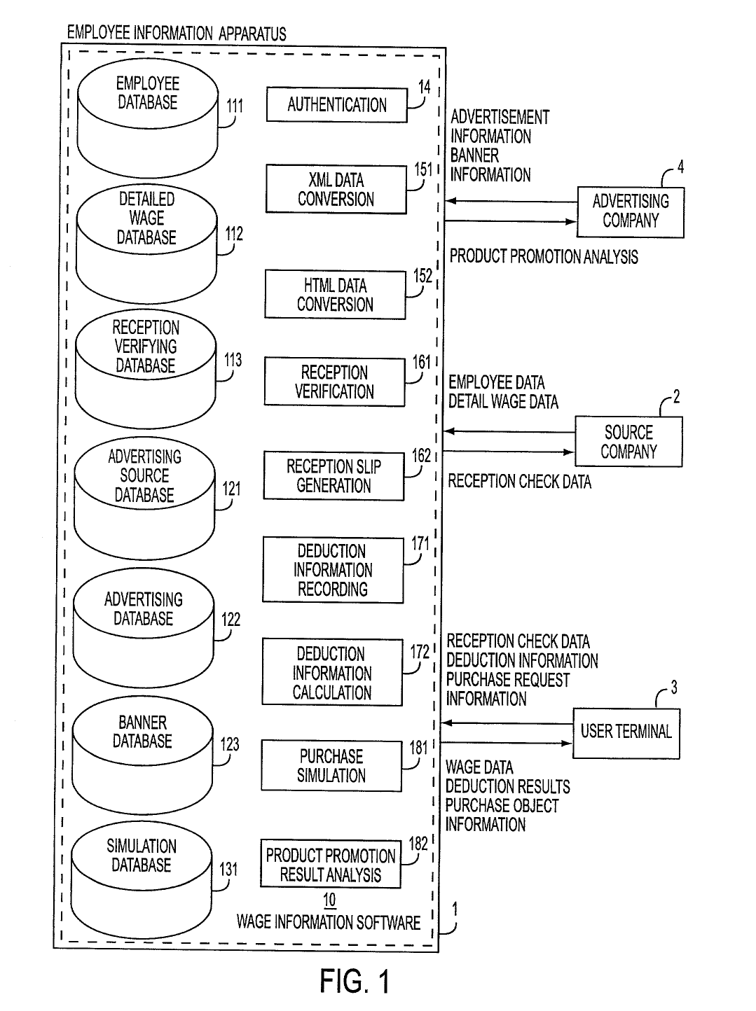

FIG. 1 shows an exemplary embodiment of an employee information apparatus 1 containing wage information software 10. The employee information apparatus 1 can exchange information with advertising company 4, source company 2, and user terminal 3. Wage information software 10 can contain employee information database 111, detailed wage database 112, reception verifying database 113, advertising source database 121, advertising database 122, banner database 123 and simulation database 131. Additionally, wage information software 10 can contain the following modules: authentication 14, XML data conversion 151, HTML data conversion 152, reception verification 161, reception slip generation 162, deduction information recording 171, purchase simulation 181, and product promotion analysis 182.

A first way that the wage information apparatus 1 can be used is that the advertising company can receive a product promotion analysis and submit advertisement information banner information to be stored in the advertising source database 121. Banner information to be shown to various employees may also be stored in the banner employee database 123. The source company 2 may then send employee-detailed wage data to the employee information apparatus 1. The source company may then receive back reception check data verifying that the employee has received the employee detailed wage data. The employee detailed wage data maybe stored in the detailed wage database 112. The reception check data that is sent to the source company 2 may also be stored in the employee information apparatus 1 in the reception verifying database 113.

The employee information apparatus 1 contains both the detailed wage data from the source company 2 and the advertising company data from the advertising company 4. An independent third party can therefore provide the employee information apparatus. Both the advertising company and the source company should trust the third party. Thus, the employee information apparatus 1 can efficiently provide advertising to the employees and protect the employee detailed wage data. The source company 2, the advertising company 4, a government, an industry organization, or any now known or later devised operator of devices may operate other exemplary embodiments.

The user terminal 3 can then relate with the wage information apparatus 1 to retrieve wage data results. First, the user terminal 3 must send employee information and pass security verification. User terminal 3 can then submit reception check data and receive wage data. In addition, several what-ifs scenarios can be used by having the user terminal 3 send additional information to the wage information apparatus 1.

The employee information apparatus 1 can then utilize the deduction information or any other information sent from user terminal 3 to conduct a deduction information calculation 172. Thus, complicated what-if scenarios can be provided to the user terminal 3. For example, employees can be shown possible earnings or deduction shortfalls based on donations or deductions accounting for additional jobs, spouses' income, or bonuses as contained in simulation database 131. In addition, the wage information apparatus 1 can help the employee calculate a life insurance policy cost using such information as the employee's wages, their spouse's wages, etc.

In addition, the user terminal 3 is provided with banner information from banner database 123. The employee using user terminal 3 may thereby elect to purchase a product from the advertising company. The employee information apparatus 1 may then use the purchase simulation function 181 to provide detailed examples of the results of an employee's purchase of the advertising company product.

In addition, the advertising company 4 may be provided with product promotion analyzing information from the product promotion analyzer 182. This feedback may be given in aggregate to the advertising company 4 such that privacy is ensured for employees of the company.

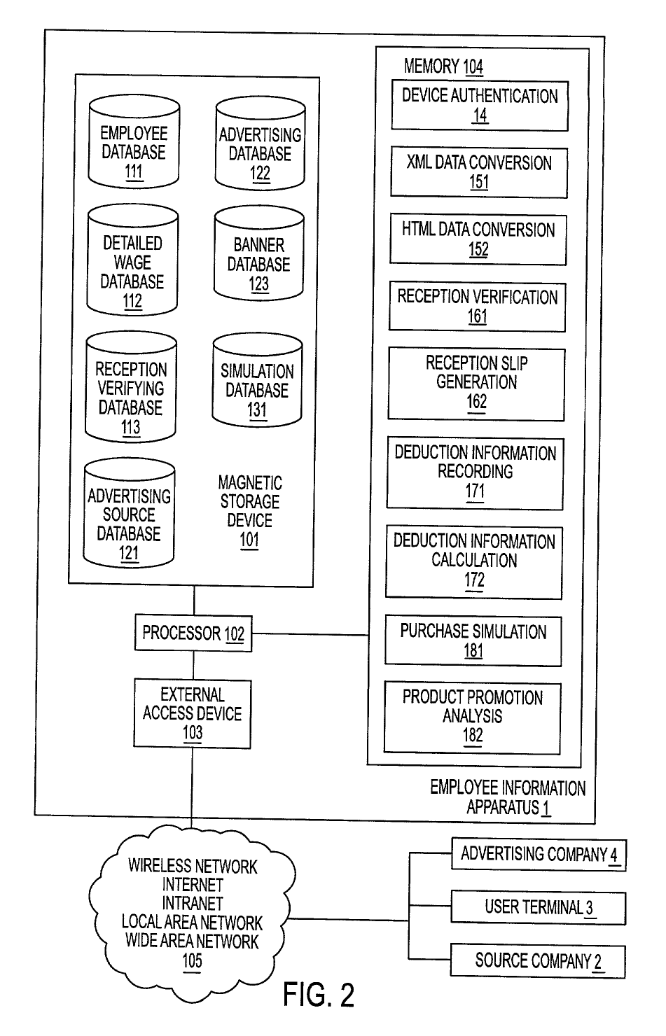

FIG. 2 shows another exemplary embodiment of an employee information apparatus 1 containing a magnetic storage device 101, a processor 102, an external access device 103 and a memory 104. The employee information apparatus 1 can exchange information with the advertising company 4, source company 2, and user terminal 3 via any of a wireless network, the Internet, an Intranet, a local area network and a wide area network 105. Magnetic storage device 101 can contain employee database 111, detailed wage database 112, reception verifying database 113, advertising source database 121, advertising database 122, banner database 123 and simulation database 131. Memory 104 can contain the following modules: authentication 14, XML data conversion 151, HTML data conversion 152, reception verification 161, reception slip generation 162, deduction information recording 171, purchase simulation 181, and product promotion analysis 182.

The employee information apparatus works in a manner similar to that described above in relation to FIG. 1. Various exemplary embodiments can subdivide or combine the shown structures as would be known by one in the art. The modules for authentication 14, XML data conversion 151, HTML data conversion 152, reception verification 161, reception slip generation 162, deduction information recording 171, purchase simulation 181, and product promotion analysis 182 can be computer code or micro code written in C++, JAVA, or any other now known or later devised programming language.

The employee database 111, detailed wage database 112, reception verifying database 13, advertising source database 121, advertising database 122, banner database 123 and simulation database 131 can be physical structures or representations stored on magnetic media in a format such as SQL server, Dbase, Oracle, or any now known or later devised format for storing data for organized retrieval.

Employee information apparatus 1 is shown for simplicity as a single device. Other exemplary embodiments can use multiple devices, or a portion of another device, as the employee information apparatus 1, as would be known by one in the art. The wireless network, the Internet, an Intranet, a local area network and a wide area network 105 is shown as a single cloud, for simplicity. Other exemplary embodiments can us any combination of the named types of networks, in addition to other and later devised networks, to communicate with the advertising company 4, user terminal 3 and source company 2. The advertising company 4, user terminal 3 and source company 2 can be an individual, a corporation, a partnership, or any other known or later devised organization that engages in the roles described above.

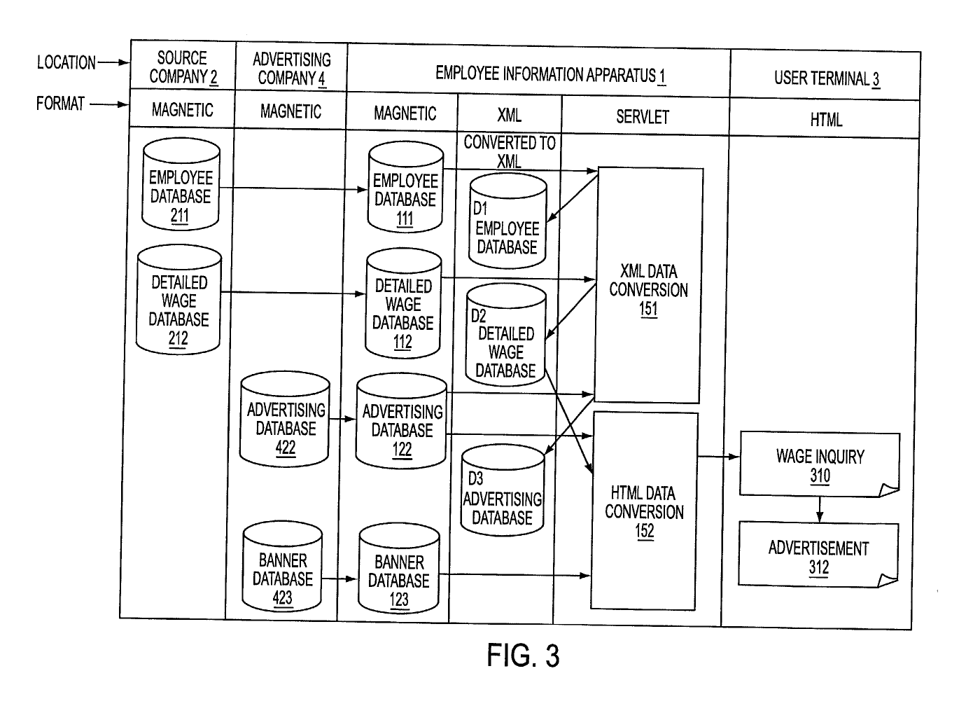

FIG. 3 illustrates an exemplary method for producing an employee wage inquiry information in a wage inquiry image 310. As shown in FIG. 1, the production of a wage inquiry image 310 can use four different locations. The first location is the source company 2. The source company 2 has a data file 211 of employee data. The source company also has a detailed wage data file with detailed wage data 212 in it. Both employee data 211 and detailed wage data 212 are transferred to the employee information apparatus 1.

Advertising company 4 also has data in the advertising database 422 and a banner database 423. The advertising information in the advertising database 422 and the banner information in the banner database 423 are both sent to the employee information apparatus 1 to be stored in the advertising database 122 and the banner database 123. Any necessary conversions can be handled by either the advertising company 4 or the employee information apparatus 1, by any method known or later devised.

Source company 2 has information, for example, in employee database 211 and detailed wage database 212. The employee information and the detailed wage information can be sent to the employee information apparatus 1 to be stored in the employee database 111, and the detailed wage database 112. Any necessary conversions can be handled by either the source company 2 or the employee information apparatus 1, by any method as is known or later devised.

Employee information apparatus and method 1 then converts the employee information in employee database 111, detailed wage database 112, advertisement database 122 to Extensable Markup Language (XML) data in the XML data conversion process 151. The XML may be stored as employee database D1, detailed wage database D2 and advertising database D3. The XML data conversion process 151 then transfers information to the HTML data conversion process 152 which can add in banner information from banner database 123. The HTML image from HTML data conversion process 152 is then transferred to the user terminal 3 in the form of the wage inquiry image 310 which has the advertising image 312 embedded in it.

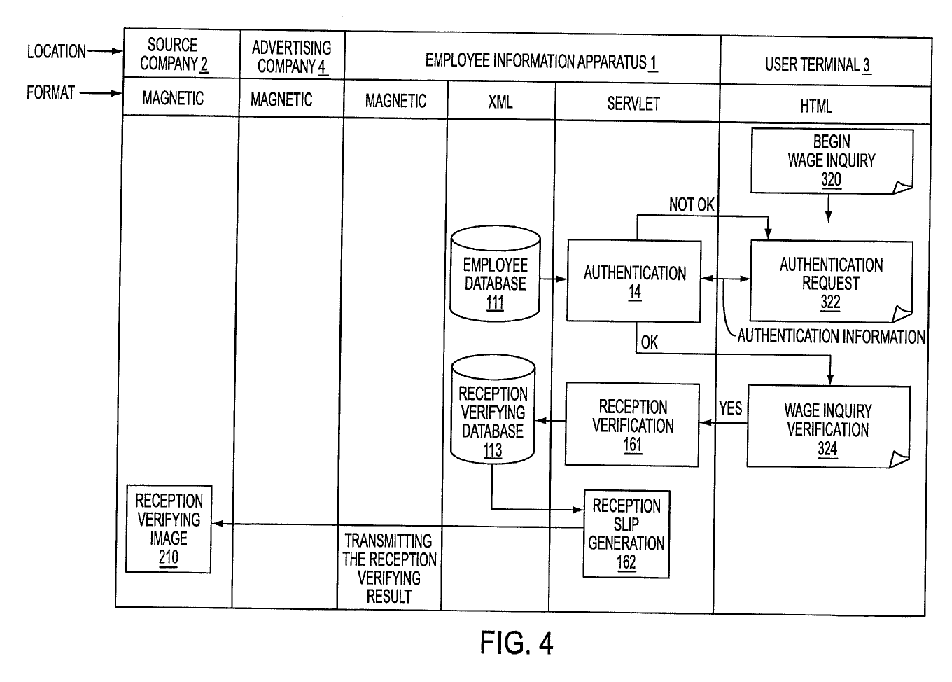

FIG. 4 shows the authentication process within the wage information apparatus 1. The process begins with a wage inquiry 320 generated by the user terminal 3. The wage inquiry 320 generates an authentication request 322. The authentication request 322 then passes authentication information to authentication 14 within the wage information apparatus 1. If the authentication information is not ok the process returns to the authentication request 322. If the authentication information is ok based on the information from the employee database 111, the process continues to the wage inquiry verification 324.

Wage inquiry verification 324 sends reception verification to the reception verification process 161 within the wage information apparatus 1. The reception verification process 161 saves a record to the reception verifying database 113. The reception verifying database 113 produces a reception slip generation 162.

Reception slip generation process 162 produces a reception verification slip 210. The reception verification slip 210 gets transmitted to the source company 2 so that it knows an employee has received his/her detailed wage information.

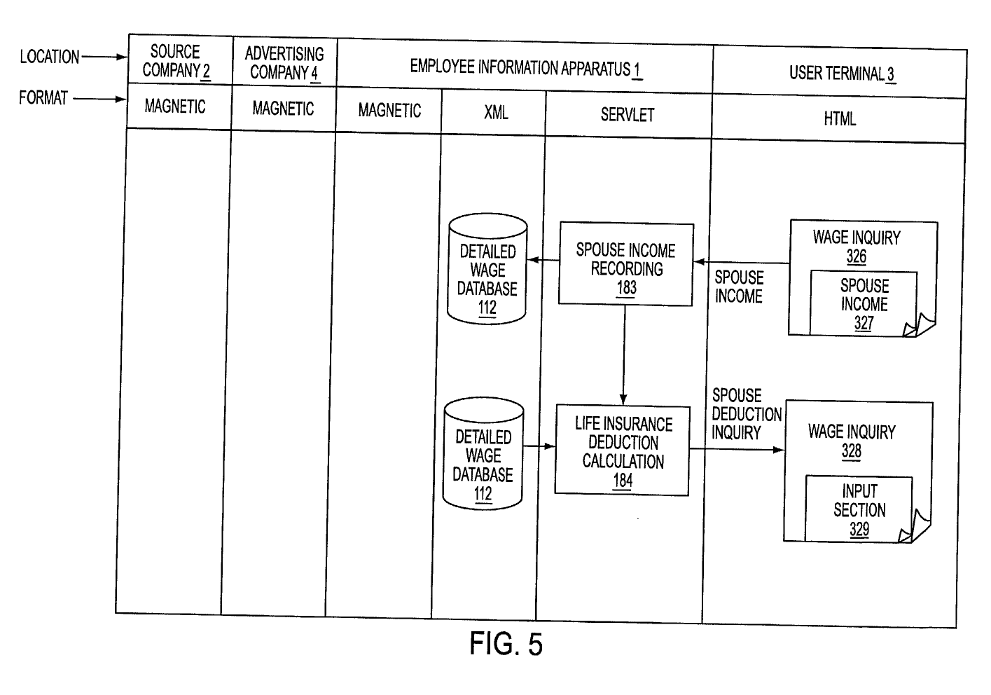

FIG. 5 shows an exemplary method of a what-if scenario. The process begins at wage inquiry image 326. The wage inquiry image 326 information includes spousal income image 327. The wage inquiry image 326 information is passed to the spouse income recording 183.

The spouse income recording 183 stores, at least temporarily, the spouse information in the detailed wage database 112 as well as calculating a life insurance deduction calculation 184. Additional information can be gathered from the detailed wage database 112. The information is then transferred back to the user terminal 3 to produce the wage inquiry image 328, which includes the spouse deduction inquiry. The wage inquiry image 328 information 328 may also include an input section 329.

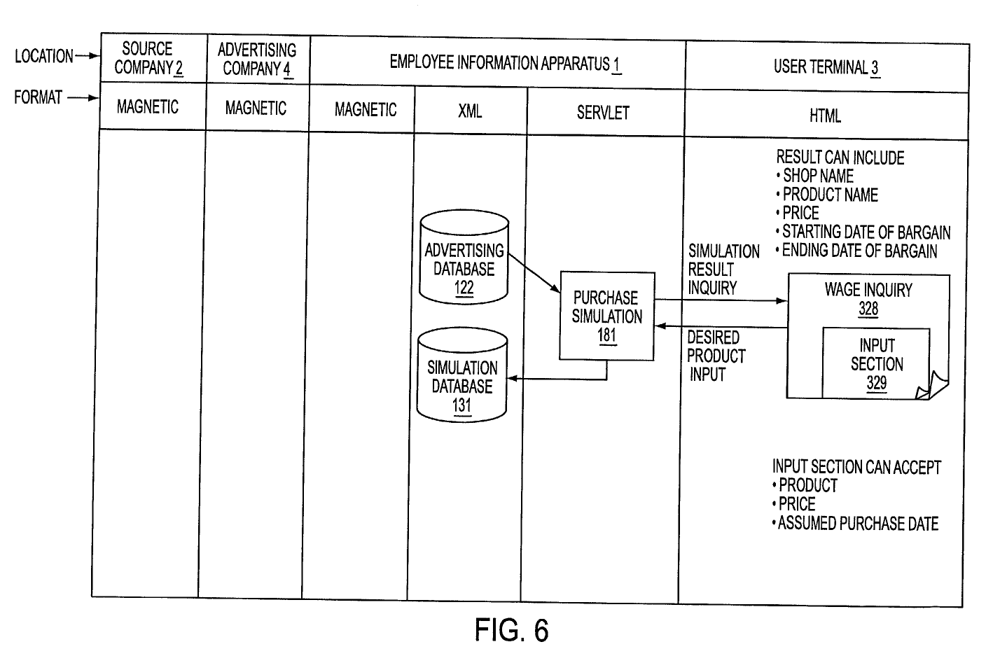

FIG. 6 describes an exemplary process for allowing an employee to purchase a product from the advertising company 4. The process begins with the user terminal 3 and a wage inquiry image 328 where the user selects to find out additional information about an advertiser's product. The wage inquiry image 328 may include an input section 329 that allows the user to send information about the product the user desires.

The wage inquiry image 328 sends the desired product input to purchase simulation 181. Purchase simulation 181 sends user information to the simulation database 131, which replies with simulation specific information. The advertisement database 122 also sends information to the purchase simulation 181. Thereupon, the purchase simulation 181 sends information such as the product name, the price, the starting date or the ending date of a bargain or of any other information needed to the wage inquiry image 328.

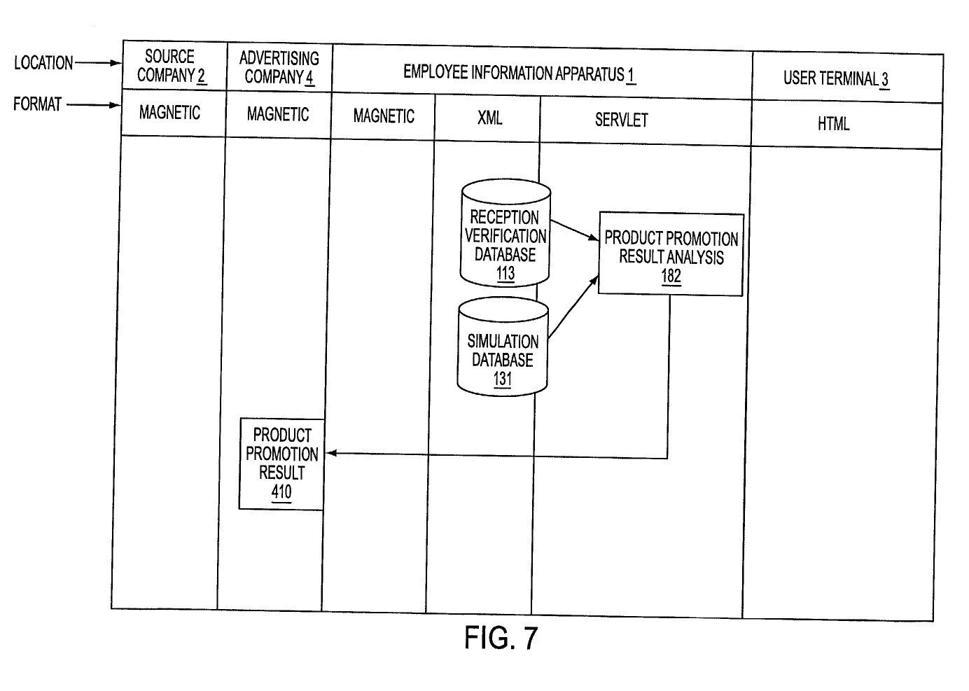

FIG. 7 shows an exemplary method for giving the results of the advertisement to the advertising company 4. The process starts with the product promotion result analysis 182. The production promotion result analysis 182 receives information from the reception verification database 113 in the simulation database 131. The product promotion result analysis then computes the results of the advertisement and sends the product promotion result to the advertisement company 4 via a product promotion result 410. Thus the advertising company can receive data about the effectiveness of the advertising, without sacrificing the privacy of the employee or the company. Thus the value of the advertising can be increased, funding additional features for the wage information apparatus 1, or any other recipient as is known.

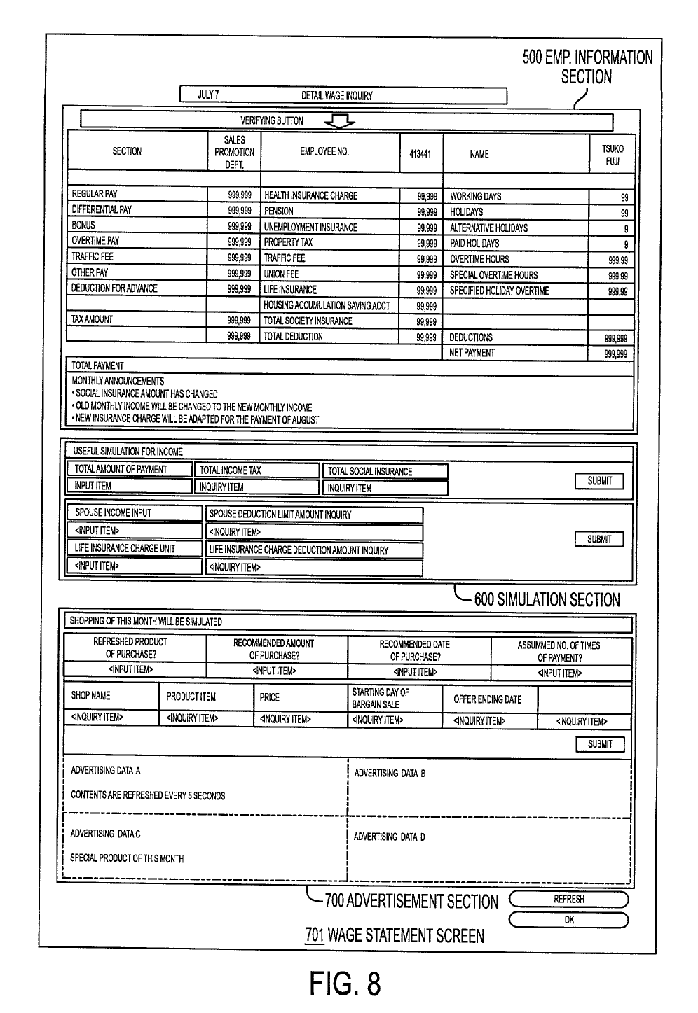

FIG. 8 shows an exemplary wage statement screen shot 701 for the detailed wage inquiry image 310. Detailed Wage Statement Screen 701 includes employee information section 500, simulation section 600 and advertising section 700.

The employee information section 500 may include such information as the employee number, the employee name, the predetermined number of working days, or working days of holidays, alternative holidays, paid holidays, normal overtime hours, midnight overtime hours, specified holiday overtime, deductions and net payment. Further, the employee information section may contain such information as regular pay, differential pay, bonus pay, overtime pay, traffic fees and other payment. The employee information section may include deductions such as health insurance charge, welfare, pension, employment insurance, property tax, traffic fee deduction, union fees, life insurance charges, housing accumulation savings, total society insurance and total deductions.

Simulation section 600 may include such items as a total amount of payment, input items, total income taxed, inquiry items, total social insurance, spousal income, life insurance charges, shopping estimation, spousal deduction, limited amount inquiries, life insurance charges, deduction amount, inquiries or other items.

The advertisement section 700 may include such items as shop name, product price, recommended amount of purchase, refreshed product item, recommended data purchase, assumed number of payments, advertising data, offer end date, offer beginning date, special products for this month, etc.

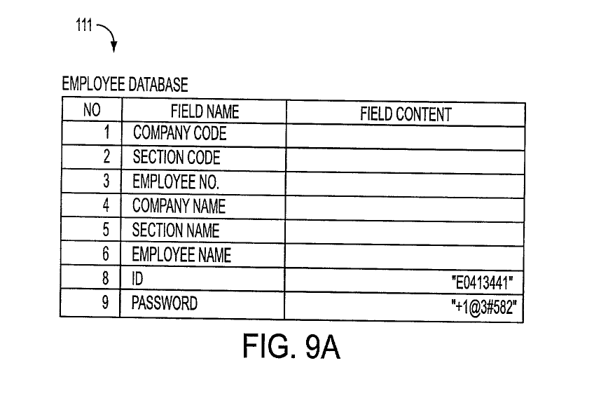

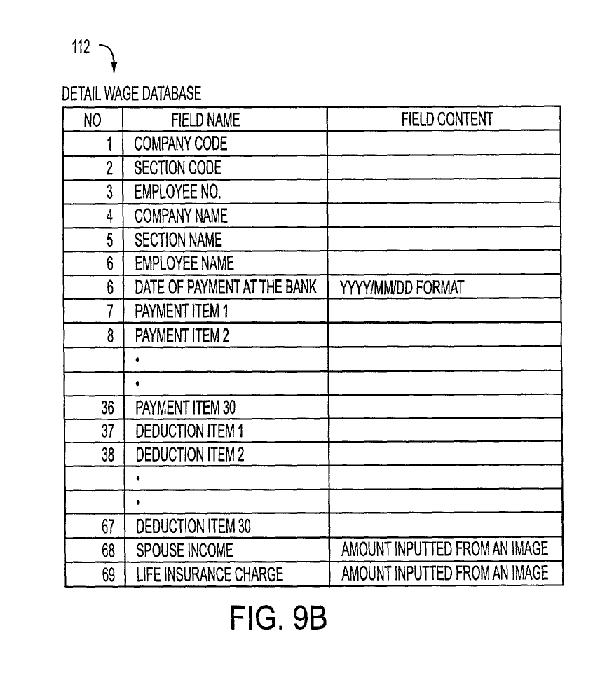

FIG. 9A shows an exemplary embodiment of an employee database table as may be used in the employee information apparatus 1. The database shown in 8A may include such fields as the company code, section code, employee number, company name, section name, employee name, ID and a password.

FIG. 9B is an exemplary embodiment of the data structure of the detailed wage database as used in the employee information apparatus 1. The detailed wage database may include such fields as company code, section code, employee number, company name, section name, employee name, date of payment at the bank, payment items 1, 2 . . . 30, deduction items 1, 2 . . . 30, spousal income and life insurance charge.

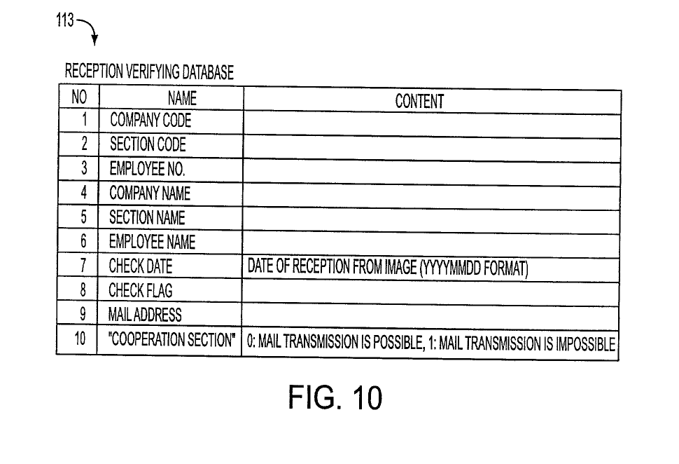

FIG. 10 shows an exemplary embodiment of the data structure of the reception verifying database 113. Reception verifying database may have such fields as company code, section code, employee number, company name, section name, employee name, check date, check flag, mail address, cooperation section, etc.

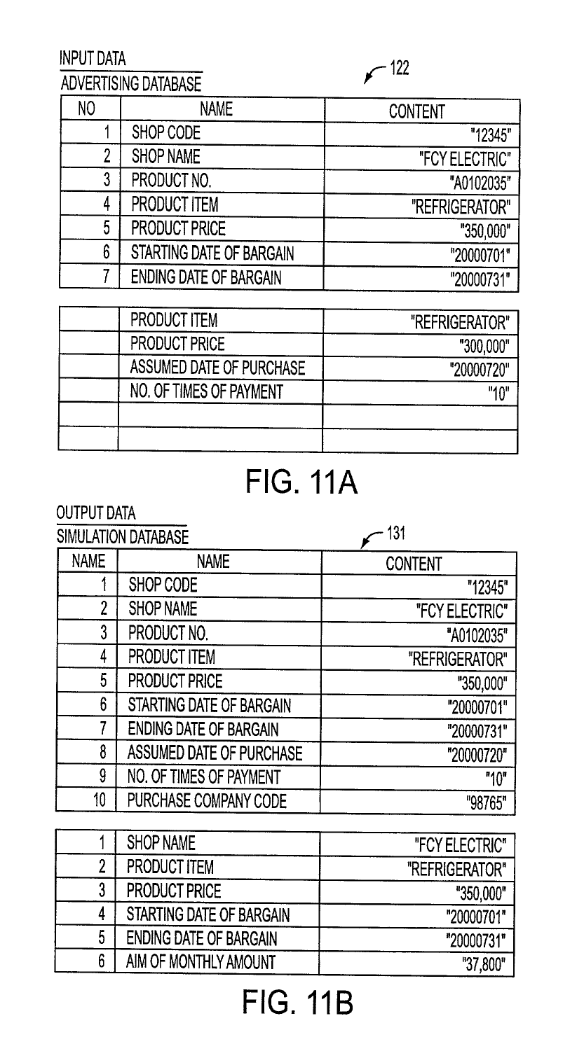

FIG. 11A is an exemplary embodiment of the data structure of the advertising database 122. The advertising database may have such fields as shop code, shop name, product number, product item, product price, starting date of bargain, ending of bargain, image of the item, product item, product price, assumed date of purchase and number of times of payment.

FIG. 11B is an exemplary embodiment of the data structure of the simulation database 131. The simulation database may contain such fields as shop code, shop name, product number, product item, product price, starting date of bargain, ending date of bargain, assumed date of purchase, number of times of payment, purchase company code, shop name, product item, product price, starting date of bargain, ending date of bargain, aim of monthly amount and the image of the inquiry item.

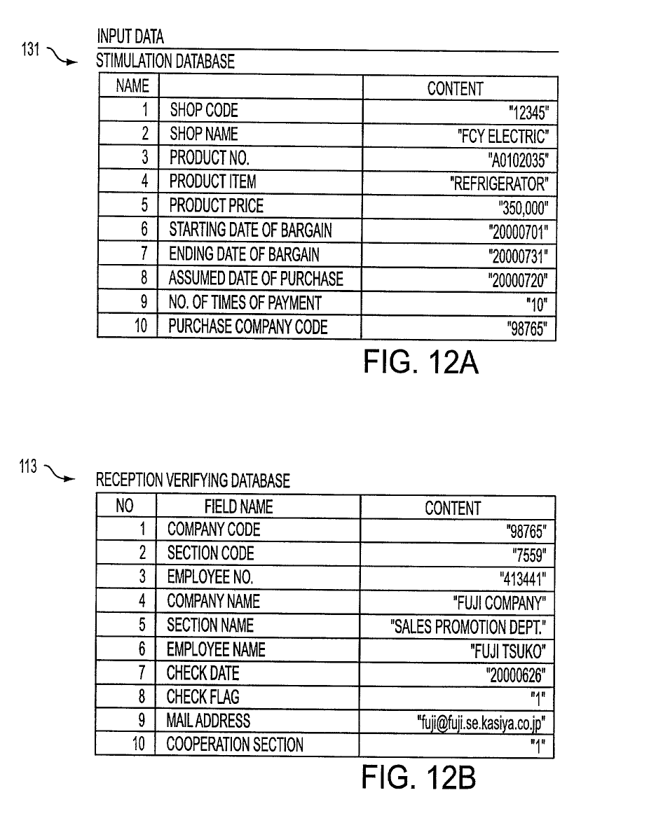

FIG. 12A is an exemplary embodiment of the data structure of the simulation database 131. The simulation database includes such fields as shop code, shop name, product number, product item, product price, starting date of bargain, ending date of bargain, assumed date of purchase, number of times of payment and purchase company code.

FIG. 12B is an exemplary embodiment of the data structure of the reception verifying database 113. The reception verifying database may have such fields as field name, company code, section code, employee number, company name, section name, employee name, check date, check flag, mail address, cooperation section.

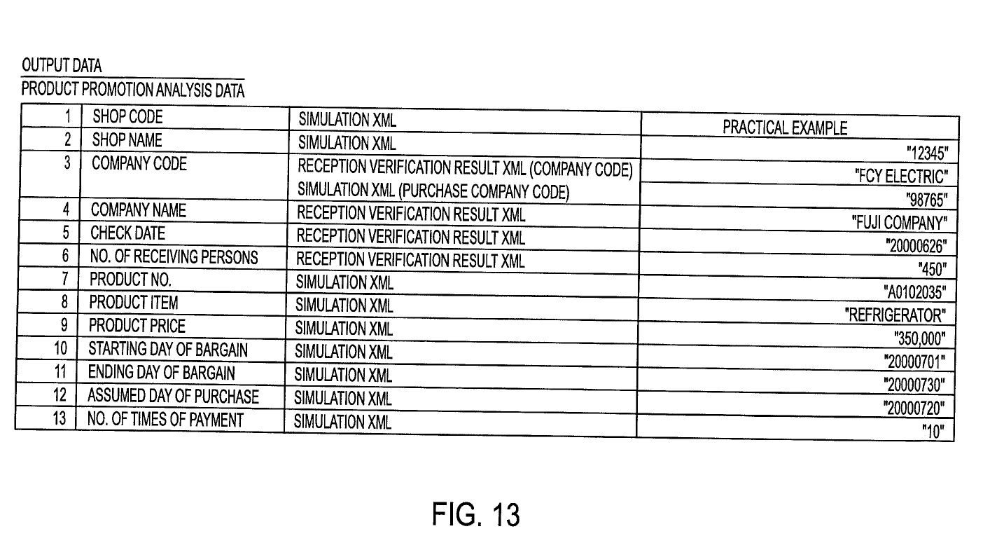

FIG. 13A is an exemplary embodiment of the data structure of the product promotion analysis data as used in the wage information apparatus 1. The product promotion analysis data may have such fields as the shop name, company code, company name, check date, number of receiving persons, product number, product item, product price, starting day of bargain, ending day of bargain, assumed day of purchase, number of times of payment, etc.

Although preferred embodiments of the invention have been shown and described, it will be appreciated by those skilled in the art that changes may be made in these embodiments without departing from the spirit and scope of the invention, the scope of which is defined in the appended claims and their equivalents.

What is claimed is:

1. An information inquiry apparatus that receives an information inquiry from a terminal connected through a communication pathway, comprising:
an inquiry information file that registers the inquiry information for each employee of a staff of an organization;
an advertisement information file that registers advertising information, possibly including an advertisement link that allows access to an additional advertisement information;
an inquiry image display generator that generates display data from the inquiry information file and the advertisement information file so that a display image of the display data contains the inquiry information for a staff of an organization and the advertising information, possibly including the advertisement link that allows access to the additional advertisement information; and
an inquiry information transmitter that receives the information inquiry from the terminal and transmits the inquiry image.

2. The information inquiry apparatus in claim 1, further comprising:
a confirmation information file that stores confirmation information when the employee submits the information inquiry from the terminal and receives the display image.

3. The information inquiry apparatus in claim 2, wherein the confirmation information is sent to the organization.

4. The information inquiry apparatus in claim 1, further comprising a purchase information file that stores purchase information when the employee utilizes the advertising information.

5. The information inquiry apparatus in claim 4, wherein the purchase information is sent to an advertisement source.

6. The information inquiry apparatus in claim 1, wherein the advertising information includes information tailored to at least one of an employee income level, an employee organizational unit and an employee information input.

7. An employee information communication method, comprising:
electronically storing employee information including at least one of employee name, employee company, employee number and employee password;
electronically storing advertising information from a first source;
electronically storing employee detailed wage information including at least one of employee number, employee company, employee name, payment amounts, deduction amounts and date of payment from a second source;
receiving an inquiry from an employee; and
generating a detailed wage image that includes advertising information, employee information and employee detailed wage information.

8. The employee information communication method in claim 7, further comprising electronically storing confirmation information when the employee submits the inquiry and receives the detailed wage image.

9. The employee information communication method in claim 8, further comprising sending the confirmation information to the second source.

10. The employee information communication method in claim 7, further comprising electronically storing purchase information when an employee utilizes the advertising information.

11. The employee information communication method in claim 10, further comprising sending the purchase information to the first source.

12. The employee information communication method in claim 7, wherein the advertising information includes information tailored to at least one of an employee income level, an employee organizational unit and an employee information input.

13. An employee information communication system, comprising:
a first electronic data storage device that stores employee information including at least one of employee name, employee company, employee number and employee password;
a second electronic data storage device that stores advertising information from a first source;
a third electronic data storage device that stores employee detailed wage information including at least one of employee number, employee company, employee name, payment amounts, deduction amounts and date of payment from a second source; and
an image generator that receives an inquiry from an employee and generates a detailed wage image that includes advertising information, employee information and employee detailed wage information.

14. The employee information system in claim 13, further comprising a fourth electronic data storage device that stores confirmation information when the employee submits the inquiry and receives the detailed wage image.

15. The employee information system in claim 14, wherein the confirmation information is sent to the second source.

16. The employee information system in claim 13, further comprising a fourth electronic data storage device that stores purchase information when an employee utilizes the advertising information.

17. The employee information system in claim 16, wherein the purchase information is sent to the first source.

18. The employee information apparatus in claim 13, wherein the advertising information includes information tailored to at least one of an employee income level, an employee organizational unit and an employee information input.

19. A wage information management apparatus, comprising:
a detailed wage data structure that stores details of an employee's wage;
a detailed wage inquiry authenticator that authenticates a wage inquiry based on an authentication code in the wage inquiry;
a communicator that, when the detailed wage authenticator authenticates the wage inquiry, sends the detailed wage data to a source of the wage inquiry;
a deduction information collector that accepts a deduction information from the source of the wage inquiry; and
a deduction information recorder that records the deduction information sent from the source of the wage inquiry.

20. The wage information management apparatus in claim 19, further comprising a confirmation data structure that stores confirmation information when the source submits the wage inquiry and the communicator sends the detailed wage data.

21. The wage information management apparatus in claim 19, wherein the confirmation information is sent to a second source.

22. An employee information communication apparatus, comprising:
a first electronic data structure that stores employee information including at least one of employee name, employee company, employee number and employee password;
a second electronic data structure that stores advertising information from a first source;
a third electronic data structure that stores employee detailed wage information including at least one of employee number, employee company, employee name, payment amounts, deduction amounts and date of payment from a second source; and
an image generator that receives an inquiry from an employee and generates a detailed wage image that includes advertising information, employee information and employee detailed wage information.
